(19) United States
(12) Patent Application Publication
(10) Pub. No.: US 2026/0063951 A1
(43) Pub. Date: Mar. 5, 2026

(54) REFLECTIVE ELECTRONIC DEVICE AND PREPARATION METHOD THEREOF

(71) Applicant: InnoLux Corporation, Miao-Li County (TW)

(72) Inventors: Huang-Cho CHEN, Miao-Li County (TW); Mei-Chi HSU, Miao-Li County (TW); Ming-Huang CHEN, Miao-Li County (TW); Jiunn-Shyong LIN, Miao-Li County (TW); I-An YAO, Miao-Li County (TW); Kuo-Liang CHUANG, Miao-Li County (TW)

(21) Appl. No.: 19/285,185

(22) Filed: Jul. 30, 2025

(30) Foreign Application Priority Data
Aug. 30, 2024 (CN) 202411208923.6

(51) Int. Cl. G02F 1/1339; G02F 1/1343; G02F 1/137

(52) U.S. Cl. CPC G02F 1/13396; G02F 1/134336; G02F 1/13718

(57) ABSTRACT

A reflective electronic device includes a first panel and a second panel. The first panel includes first and second substrates, a second substrate, a first cholesteric liquid crystal layer, a first insulation layer having a first opening, and a first main spacer having a second main surface and a first main thickness. The second panel includes third and fourth substrates, a second cholesteric liquid crystal layer, a second insulation layer having a second opening, and a second main spacer having a fourth main surface and a second main thickness. The second main surface is disposed in the first opening. The fourth main surface is disposed in the second opening. The second main thickness is greater than the first main thickness.

### CROSS-REFERENCE TO RELATED APPLICATIONS

This application claims the benefits of the Chinese Patent Application Serial Number 202411208923.6, filed on Aug. 30, 2024, the subject matter of which is incorporated herein by reference.

### BACKGROUND

### Field of the Disclosure

The present disclosure provides a reflective electronic device and a preparation method thereof and, more particularly, to a reflective electronic device having cholesteric liquid crystal and a preparation method thereof.

### Description of Related Art

Cholesteric liquid crystal is usually used in reflective panels since it has the advantage of low power consumption due to its bi-stable characteristics. Typically, the reflective electronic device may include a plurality of layers of cholesteric liquid crystal panels stacked together to reflect different colors. Thus, how to reduce the process cost and complexity of the preparation method and the design of the reflective panel has become an important issue.

Therefore, it is desired to provide an improved sensing device to alleviate and/or obviate the above problems.

### SUMMARY

The present disclosure provides a reflective electronic device having a display surface, which includes: a first panel including: a first substrate; a second substrate opposite to the first substrate; a first cholesteric liquid crystal layer disposed between the first substrate and the second substrate; a first insulation layer disposed between the first cholesteric liquid crystal layer and the second substrate, wherein the first insulation layer has a first opening; and a first main spacer disposed between the first substrate and the second substrate and provided with a first main surface, a second main surface and a first main thickness, wherein the first main surface is adjacent to the first substrate, the second main surface is adjacent to the second substrate, and an area of the first main surface is larger than an area of the second main surface; and a second panel including: a third substrate; a fourth substrate opposite to the third substrate; a second cholesteric liquid crystal layer disposed between the third substrate and the fourth substrate; a second insulation layer disposed between the second cholesteric liquid crystal layer and the fourth substrate, wherein the second insulation layer has a second opening; and a second main spacer disposed between the third substrate and the fourth substrate and provided with a third main surface, a fourth main surface and a second main thickness, wherein the third main surface is adjacent to the third substrate, the fourth main surface is adjacent to the fourth substrate, and an area of the third main surface is larger than an area of the fourth main surface, wherein the second main surface is disposed in the first opening, the fourth main surface is disposed in the second opening, and the second main thickness is greater than the first main thickness.

The present disclosure further provides a preparation method of a reflective electronic device, which includes: forming a first structure, including forming a first material layer having a first thickness on a first substrate, and using a first mask to pattern the first material layer to form a first main spacer; forming a second structure, wherein the second structure includes a second substrate; disposing a first cholesteric liquid crystal layer on the first structure or the second structure, and assembling the first structure and the second structure to form a first panel; forming a third structure, including forming a second material layer having a second thickness on a third substrate, and using the first mask to pattern the second material layer to form a second main spacer; forming a fourth structure, wherein the fourth structure includes a fourth substrate; disposing a second cholesteric liquid crystal layer on the third structure or the fourth structure, and assembling the third structure and the fourth structure to form a second panel; and assembling the first panel and the second panel, wherein the first thickness is different from the second thickness, and a first main thickness of the first main spacer is different from a second main thickness of the second main spacer.

Other novel features of the disclosure will become more apparent from the following detailed description when taken in conjunction with the accompanying drawings.

### BRIEF DESCRIPTION OF DRAWINGS

FIG. 1A is schematic diagram showing the preparation of a first structure of a reflective electronic device according to an embodiment of the present disclosure;

FIG. 1B is schematic diagram showing the preparation of a third structure of a reflective electronic device according to an embodiment of the present disclosure;

FIG. 1C is schematic diagram showing the preparation of a fifth structure of a reflective electronic device according to an embodiment of the present disclosure;

FIG. 1D is a schematic diagram showing the preparation of a first panel, a second panel, and a third panel of a reflective electronic device according to an embodiment of the present disclosure;

FIG. 2 is a schematic diagram of a reflective electronic device according to an embodiment of the present disclosure;

FIG. 3A and FIG. 3B are schematic diagrams of a second substrate and a first substrate, respectively, according to an embodiment of the present disclosure;

FIG. 4A is a schematic diagram showing the preparation of a first panel of a reflective electronic device according to another embodiment of the present disclosure;

FIG. 4B is a schematic diagram showing the preparation of a second panel of a reflective electronic device according to another embodiment of the present disclosure;

FIG. 4C is a schematic diagram showing the preparation of a third panel of a reflective electronic device according to another embodiment of the present disclosure; and

FIG. 5 is a cross-sectional view of the first secondary spacer of the reflective electronic device according to an embodiment of the present disclosure.

### DETAILED DESCRIPTION OF EMBODIMENT

The electronic device according to the embodiment of the present disclosure is described in detail below. It should be understood that the following description provides many different embodiments for implementing different aspects of some embodiments of the present disclosure. The specific components and arrangements described below are only for the purpose of simply and clearly describing some embodiments of the present disclosure. Of course, these are only examples and are not limitations of the present disclosure. In addition, similar and/or corresponding reference numerals may be used in different embodiments to identify similar and/or corresponding components in order to clearly describe the present disclosure. However, the use of these similar and/or corresponding reference numerals is only for simply and clearly describing some embodiments of the present disclosure, and does not represent any relationship between the different embodiments and/or structures discussed.

The embodiments of the present disclosure may be understood together with the drawings, and the drawings of the present disclosure are also regarded as part of the disclosure description. It should be understood that the drawings of the present disclosure are not in scale and, in fact, the dimensions of elements may be arbitrarily enlarged or reduced in order to clearly illustrate features of the present disclosure. In addition, directional terms mentioned in the specification, such as “up”, “down”, “front”, “rear”, “left”, “right”, etc., only refer to the directions of the drawings. Accordingly, the directional term used is illustrative, not limiting, of the present disclosure. In the drawings, various figures illustrate the general characteristics of methods, structures and/or materials used in particular embodiments. However, these drawings should not be construed to define or limit the scope or nature encompassed by these embodiments. For example, the relative sizes, thicknesses and positions of various layers, regions and/or structures may be reduced or enlarged for clarity.

One structure (or layer, component, substrate) described in the present disclosure is disposed on/above another structure (or layer, component, substrate), which can mean that the two structures are adjacent and directly connected, or can refer to two structures that are adjacent rather than directly connected. Indirect connection means that there is at least one intermediate structure (or intermediate layer, intermediate component, intermediate substrate, intermediate space) between the two structures, the lower surface of one structure is adjacent to or directly connected to the upper surface of the intermediate structure, and the upper surface of the other structure is adjacent to or directly connected to the lower surface of the intermediate structure. The intermediate structure may be a single-layer or multi-layer physical structure or a non-physical structure, which is not limited. In the present disclosure, when a certain structure is arranged “on” other structures, it may mean that a certain structure is “directly” on other structures, or it means that a certain structure is “indirectly” on other structures; that is, at least one structure is sandwiched, in between a certain structure and other structures.

In addition, it should be understood that, in the specification and claims, unless otherwise specified, ordinal numbers, such as “first” and “second”, used herein are intended to distinguish elements rather than disclose explicitly or implicitly that names of the elements bear the wording of the ordinal numbers. The ordinal numbers do not imply what order an element and another element are in terms of space, time or steps of a manufacturing method. Thus, what is referred to as a “first element” in the specification may be referred to as a “second element”in the claims.

In some embodiments of the present disclosure, terms such as “connection” and “interconnection” about joining and connecting, unless otherwise specified, may mean that two structures are in direct contact, or may also mean that two structures are not in direct contact, where other structures are placed between the two structures. Moreover, the terms about joining and connecting may also include the situation that both structures are movable, or both structures are fixed. In addition, the term “couple” includes any direct and indirect means of electrical connection.

In the description, the terms “almost”, “about”, “approximately” or “substantially” usually means within 10%, 5%, 3%, 2%, 1% or 0.5% of a given value or range. The quantity given here is an approximate quantity; that is, without specifying “almost”, “about”, “approximately” or “substantially”, it can still imply the meaning of “almost”, “about”, “approximately” or “substantially”. In addition, the term “range of the first value to the second value” or “range between the first value and the second value” indicates that the range includes the first value, the second value, and other values in between. In the present disclosure, the term “a given range is from a first value to a second value” or “a given range is within a range from the first value to the second value” means that the given range includes the first value, the second value and other values between the first and second values.

Furthermore, according to the embodiments of the present disclosure, an optical microscope (OM), a scanning electron microscope (SEM), a thin film thickness profiler (α-step), an ellipsometer, or other suitable methods may be used to measure the thickness, length, width of each component or the distance and angle between components. In detail, according to some embodiments, a scanning electron microscope may be used to obtain a cross-sectional image of a structure and measure the thickness, length, width of each component or the distance and angle between components.

In the entire specification and the appended claims of the present disclosure, certain words are used to refer to specific components. Those skilled in the art should understand that electronic device manufacturers may refer to the same components by different names. The present disclosure does not intend to distinguish those components with the same function but different names. In the claims and the following description, the words “comprise”, “include” and “have” are open type language, and thus they should be interpreted as meaning “including but not limited to”. Therefore, when the terms “comprise”, “include” and/or “have” are used in the description of the present disclosure, they specify the existence of corresponding features, regions, steps, operations and/or components, but do not exclude the existence of one or more corresponding features, regions, steps, operations and/or components.

It should be noted that the following embodiments may be replaced, reorganized, and mixed to complete other embodiments without departing from the spirit of the present disclosure. As long as the features of the various embodiments do not violate the spirit of the invention or conflict with each other, they can be mixed and matched arbitrarily.

Unless otherwise defined, all terms (including technical and scientific terms) used herein have the same meaning as commonly understood by one of ordinary skill in the art to which this disclosure belongs. It may be understood that these terms, such as those defined in commonly used dictionaries, should be interpreted as having meanings consistent with the background or context of the related technology and the present disclosure, and should not be interpreted in an idealized or overly formal manner, unless otherwise specified in the embodiments of the present disclosure. The present disclosure may be understood by referring to the following detailed description in conjunction with the accompanying drawings. It should be noted that, in order to facilitate the understanding of the readers and for the simplicity of the drawings, the multiple drawings in the present disclosure only depict a portion of the electronic device, and the specific components in the drawings are not drawn according to the actual scale. In addition, the number and size of each component in the figure are only for illustration and are not intended to limit the scope of the present disclosure.

The electronic device of the present disclosure may include electronic components. Electronic components may include passive components, active components, or a combination thereof, such as capacitors, resistors, inductors, varactors, variable capacitors, filters, diodes, transistors, sensors, micro-electromechanical system components (MEMS), liquid crystal chips, etc., but not limited thereto. The diodes may include light emitting diodes or non-light emitting diodes. The diode includes a P-N junction diode, a PIN diode or a constant current diode. The light emitting diode may include, for example, an organic light emitting diode (OLED), a mini LED, a micro LED, a quantum dot LED, fluorescence, phosphor or other suitable materials, or a combination thereof, but not limited thereto. The sensor may include, for example, a capacitive sensor, an optical sensor, an electromagnetic sensor, a fingerprint sensor (FPS), a touch sensor, an antenna, or a pen sensor, but not limited thereto. The following description will use a display device as an electronic device to illustrate the present disclosure, but the present disclosure is not limited thereto.

The electronic device may include an imaging device, a bonding device, a display device, a backlight device, an antenna device, a tiled device, a touch display, a curved display, or a free shape display, but not limited thereto. The electronic device may include, for example, liquid crystal, light emitting diode, fluorescence, phosphor, other suitable display media, or a combination thereof, but not limited thereto. The display device may be a non-self-luminous display device or a self-luminous display device. The antenna device may be a liquid crystal type antenna device or a non-liquid crystal type antenna device, and the sensing device may be a sensing device that senses capacitance, light, heat energy, or ultrasound, but not limited thereto. The tiled device may be, for example, a display tiled device or an antenna tiled device, but not limited thereto. It should be noted that the electronic device may be any arrangement or combination of the aforementioned, but not limited thereto. The electronic device may be a bendable or flexible electronic device. It should be noted that the electronic device may be any arrangement or combination of the aforementioned, but not limited thereto. In addition, the shape of the electronic device may be rectangular, circular, polygonal, a shape with curved edges, or other suitable shapes. The electronic device may have peripheral systems such as a driving system, a control system, a light source system, a shelf system, etc. to support a display device, an antenna device, or a tiled device. It should be noted that the following embodiments may be implemented by replacing, reorganizing, or mixing features of several different embodiments without departing from the spirit of the present disclosure to implement other embodiments. The features of the various embodiments may be mixed and matched as desired as long as they do not violate the spirit of the disclosure or conflict with each other. It should be noted that the technical solutions provided in the following different embodiments may be replaced, combined or mixed with each other to form another embodiment without violating the spirit of the present disclosure.

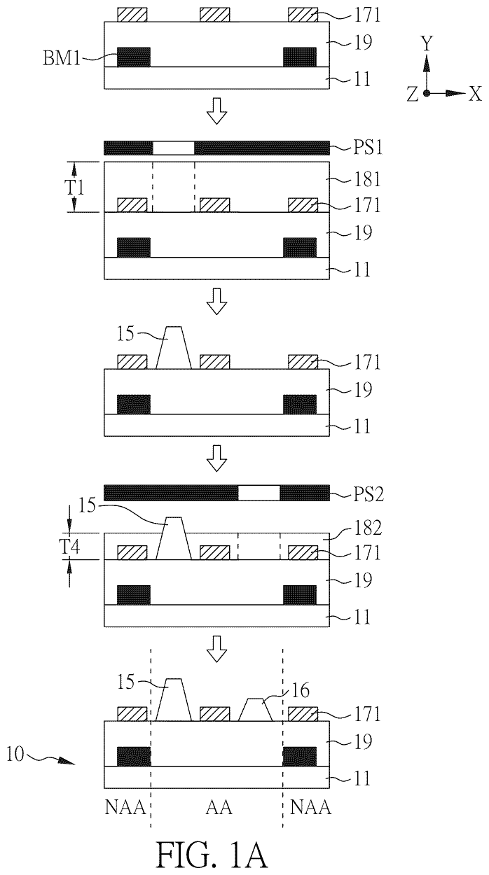

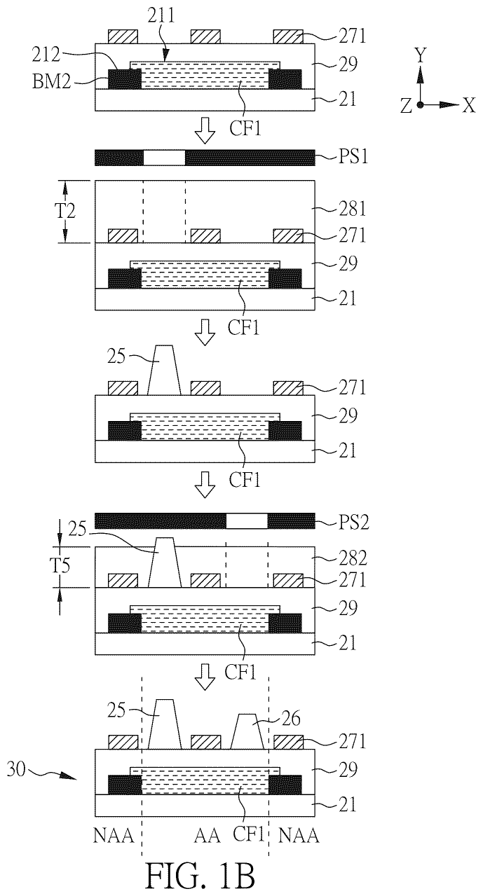

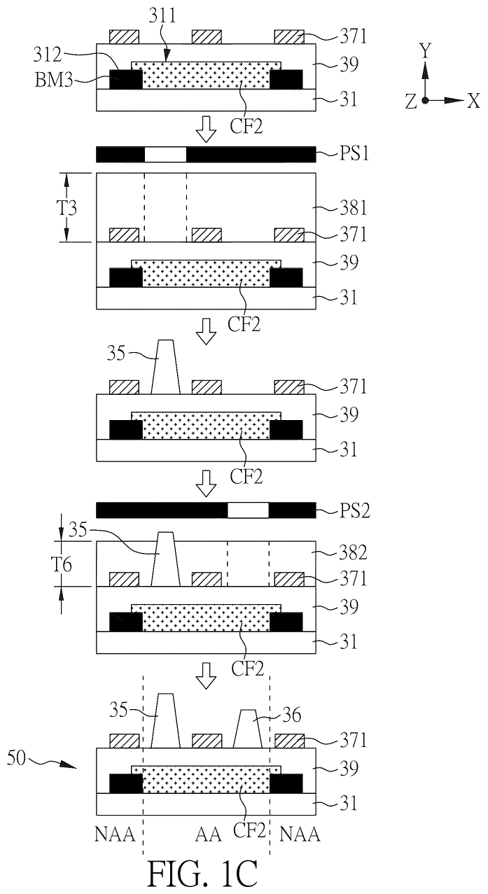

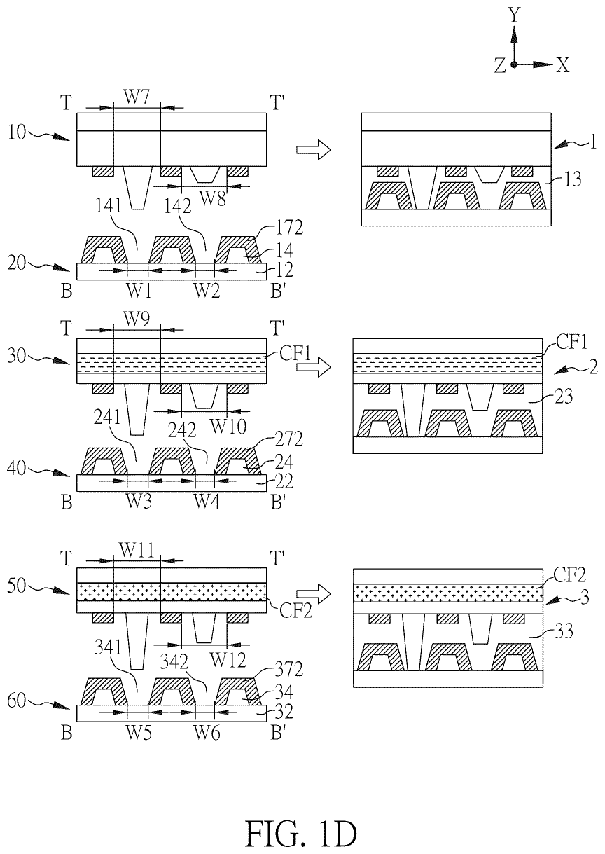

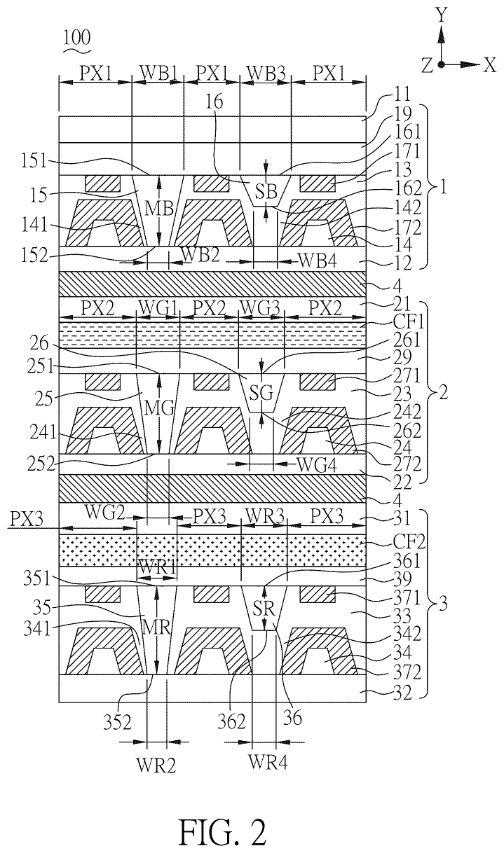

FIG. 1A to FIG. 1C are schematic diagrams showing the preparation of a first structure, a third structure, and a fifth structure of a reflective electronic device according to an embodiment of the present disclosure, FIG. 1D is a schematic diagram showing the preparation of a first panel, a second panel, and a third panel of a reflective electronic device according to an embodiment of the present disclosure, and FIG. 2 is a schematic diagram of a reflective electronic device according to an embodiment of the present disclosure, wherein FIG. 1D and FIG. 2 show the active area of the reflective electronic device, but do not show the non-active area and, for the purpose of clarity, some components of FIG. 1A to FIG. 1C are not shown in FIG. 1D and FIG. 2.

In one embodiment of the present disclosure, a preparation method of the first panel 1 of the reflective electronic device 100 includes the following steps. As shown in FIG. 1A, a first structure 10 is formed by including forming a first material layer 181 having a first thickness T1 on a first substrate 11, and patterning the first material layer 181 using a first mask PS1 to form a first main spacer 15. Then, as shown in FIG. 1D, a second structure 20 is formed. The second structure 20 includes a second substrate 12. Next, as shown in FIG. 1D, a first cholesteric liquid crystal layer 13 is disposed on the first structure 10 or the second structure 20, and the first structure 10 and the second structure 20 are assembled to form a first panel 1. The first thickness T1 is, for example, an average of thicknesses at any three locations of the first material layer 181.

In addition, as shown in FIG. 1A, when forming the first structure 10, the preparation method of the first panel 1 of the reflective electronic device 100 may further include: forming a fourth material layer 182 having a fourth thickness T4 on the first substrate 11, and using a second mask PS2 to pattern the fourth material layer 182 to form a first secondary spacer 16. The fourth thickness T4 is, for example, an average of thicknesses at any three locations of the fourth material layer 182.

In one embodiment of the present disclosure, a preparation method of the second panel 2 of the reflective electronic device 100 includes the following steps. As shown in FIG. 1B, a third structure 30 is formed by includes forming a second material layer 281 having a second thickness T2 on a third substrate 21, and patterning the second material layer 281 using a first mask PS1 to form a second main spacer 25. Then, as shown in FIG. 1D, a fourth structure 40 is formed, and the fourth structure 40 includes a fourth substrate 22. Next, as shown in FIG. 1D, a second cholesteric liquid crystal layer 23 is disposed on the third structure 30 or the fourth structure 40, and the third structure 30 and the fourth structure 40 are assembled to form a second panel 2. The second thickness T2 is, for example, an average of thicknesses at any three locations of the second material layer 281.

In addition, as shown in FIG. 1B, when forming the third structure 30, the preparation method of the second panel 2 of the reflective electronic device 100 may further include: forming a fifth material layer 282 having a fifth thickness T5 on the third substrate 21, and using a second mask PS2 to pattern the fifth material layer 282 to form a second secondary spacer 26. The fifth thickness T5 is, for example, an average of thicknesses at any three locations of the fifth material layer 282.

In one embodiment of the present disclosure, a preparation method of the third panel 3 of the reflective electronic device 100 includes the following steps. As shown in FIG. 1C, a fifth structure 50 is formed by including forming a third material layer 381 having a third thickness T3 on a fifth substrate 31, and patterning the third material layer 381 using a first mask PS1 to form a third main spacer 35. Then, as shown in FIG. 1D, a sixth structure 60 is formed, and the sixth structure 60 includes a sixth substrate 32. Next, as shown in FIG. 1D, a third cholesteric liquid crystal layer 33 is disposed on the fifth structure 50 or the sixth structure 60, and the fifth structure 50 and the sixth structure 60 are assembled to form a third panel 3. The third thickness T3 is, for example, an average of thicknesses at any three locations of the third material layer 381.

In addition, as shown in FIG. 1C, when forming the fifth structure 50, the preparation method of the third panel 3 of the reflective electronic device 100 may further include: forming a sixth material layer 382 having a sixth thickness T6 on the fifth substrate 31, and using a second mask PS2 to pattern the sixth material layer 382 to form a third secondary spacer 36. The sixth thickness T6 is, for example, an average of thicknesses at any three locations of the sixth material layer 382.

As shown in FIG. 2, after the first panel 1, the second panel 2, and the third panel 3 are completed, the preparation method of the reflective electronic device 100 may further include: assembling the first panel 1, the second panel 2, and the third panel 3 to complete the reflective electronic device 100 of the present disclosure.

Next, the preparation methods of the first structure 10, the second structure 20, the third structure 30, the fourth structure 40, the fifth structure 50 and the sixth structure 60 will be described in detail.

As shown in FIG. 1A, in one embodiment of the present disclosure, a first substrate 11 is provided, a patterned first black matrix layer BM1 is formed on the first substrate 11, a first protective layer 19 is formed on the first black matrix layer BM1, and a plurality of first electrodes 171 are formed on the first protective layer 19. The first protective layer 19 may be, for example, a planarization layer, which may be made by a transparent organic material. The first substrate 11 may include an active area AA and a non-active area NAA, wherein the non-active area NAA is disposed adjacent to the active area AA, and the first black matrix layer BM1 is disposed on the non-active area NAA, for example, to reduce side light leakage, but it is not limited thereto. In other embodiments (not shown), the first black matrix layer BM1 may also be disposed in a portion of the non-secondary pixel area of the active area AA. The active area AA may include, for example, all pixel areas, and the non-active area NAA may include, for example, a peripheral circuit area (not shown). Next, a first material layer 181 having a first thickness T1 is formed on the first substrate 11, and the first material layer 181 is patterned using a first mask PS1 to form a first main spacer 15. Subsequently, a fourth material layer 182 having a fourth thickness T4 is formed on the first substrate 11, and the fourth material layer 182 is patterned using a second mask PS2 to form a first secondary spacer 16, thereby forming a first structure 10. The stacked layers of the first structure 10 are only examples, and other stacked layers (other inorganic or organic layers), alignment layers (not shown), and wiring layers (not shown) may be added as required.

As shown in FIG. 1B, in one embodiment of the present disclosure, a third substrate 21 is provided, and a patterned second black matrix layer BM2 and a first color filter layer CF1 are sequentially formed on the third substrate 21. The first color filter layer CF1 may be disposed, for example, in the opening 211 of the second black matrix layer BM2 and may selectively partially cover the upper surface 212 of the second black matrix layer BM2, but it is not limited thereto. Subsequently, a second protective layer 29 is formed on the second black matrix layer BM2 and the first color filter layer CF1. The second protective layer 29 may be a planarization layer, for example, made of a transparent organic material. A plurality of second electrodes 271 are formed on the second protective layer 29. The third substrate 21 may include an active area AA and a non-active area NAA. The non-active area NAA is disposed adjacent to the active area AA, and the second black matrix layer BM2 is disposed on the non-active area NAA to reduce side light leakage. In other embodiments (not shown), the second black matrix layer BM2 may also be disposed in a portion of the non-sub-pixel area of the active area AA. Next, a second material layer 281 having a second thickness T2 is formed on the third substrate 21, and the second material layer 281 is patterned using a first mask PS1 to form second main spacers 25. Subsequently, a fifth material layer 282 having a fifth thickness T5 is formed on the third substrate 21, and the fifth material layer 282 is patterned using a second mask PS2 to form a second secondary spacer 26, thereby forming a third structure 30. The above stacked layers of the third structure 30 are only examples, and other stacked layers (other inorganic or organic layers), alignment layers (not shown), and wiring layers (not shown) may be added according to needs.

As shown in FIG. 1C, in one embodiment of the present disclosure, a fifth substrate 31 is provided, and a patterned third black matrix layer BM3 and a second color filter layer CF2 are sequentially formed on the fifth substrate 31. The second color filter layer CF2 may be disposed, for example, in the opening 311 of the third black matrix layer BM3 and may selectively partially cover the upper surface 312 of the third black matrix layer BM3, but it is not limited thereto. Subsequently, a third protective layer 39 is formed on the third black matrix layer BM3 and the second color filter layer CF2. The second protective layer 29 may be a planarization layer, which may be made of a transparent organic material. A plurality of third electrodes 371 are formed on the third protective layer 39. The fifth substrate 31 may include an active area AA and a non-active area NAA. The non-active area NAA is disposed adjacent to the active area AA, and the third black matrix layer BM3 is disposed on the non-active area NAA to reduce side light leakage. In other embodiments (not shown), the third black matrix layer BM3 may also be disposed in a portion of the non-sub-pixel area of the active area AA. Next, a third material layer 381 having a third thickness T3 is formed on the fifth substrate 31, and the third material layer 381 is patterned using a first mask PS1 to form third main spacers 35. Subsequently, a sixth material layer 382 having a sixth thickness T6 is formed on the fifth substrate 31, and the sixth material layer 382 is patterned using a second mask PS2 to form a third secondary spacer 36, thereby obtaining a fifth structure 50. The stacked layers of the fifth structure 50 are only examples, and other stacked layers (other inorganic or organic layers), alignment layers (not shown), and wiring layers (not shown) may be added as required.

As shown in FIG. 1D, in one embodiment of the present disclosure, a second substrate 12 is provided, and a first insulation layer 14 is formed on the second substrate 12. The first insulation layer 14 has a plurality of first openings 141. A plurality of portions of the first insulation layer 14 are each disposed, for example, between adjacent first openings 141, and a plurality of fourth electrodes 172 are respectively formed on the portions of the first insulation layer 14. The fourth electrodes 172 may selectively be partially filled in the first openings 141, but adjacent fourth electrodes 172 are not connected to each other (that is, electrically insulated). With the above design, a second structure 20 is obtained. Next, the first cholesteric liquid crystal layer 13 is disposed on the first structure 10 or the second structure 20, and the first structure 10 and the second structure 20 are assembled to form the first panel 1. The above stacked layers of the second structure 20 are only examples, and other stacked layers (other inorganic or organic layers), alignment layers (not shown), and wiring layers (not shown) may be added according to needs.

As shown in FIG. 1D, in one embodiment of the present disclosure, a fourth substrate 22 is provided, and a second insulation layer 24 is formed on the fourth substrate 22. The second insulation layer 24 has a plurality of second openings 241. A plurality of portions of the second insulation layer 24 are each disposed, for example, between adjacent second openings 241, and a plurality of fifth electrodes 272 are respectively formed on the portions of the second insulation layer 24. The fifth electrodes 272 may selectively be partially filled in the second openings 241, but adjacent fifth electrodes 272 are not connected to each other (that is, electrically insulated). With the above design, a fourth structure 40 is obtained. Next, the second cholesteric liquid crystal layer 23 is disposed on the third structure 30 or the fourth structure 40, and the third structure 30 and the fourth structure 40 are assembled to form the second panel 2. The stacked layers of the fourth structure 40 are only examples, and other stacked layers (other inorganic or organic layers), alignment layers (not shown), and wiring layers (not shown) may be added as required.

As shown in FIG. 1D, in one embodiment of the present disclosure, a sixth substrate 32 is provided, and a third insulation layer 34 is formed on the sixth substrate 32. The third insulation layer 34 has a plurality of third openings 341. A plurality of portions of the third insulation layer 34 are each disposed, for example, between adjacent third openings 341, and a plurality of sixth electrodes 372 are respectively formed on the portions of the third insulation layer 34. The sixth electrodes 372 may selectively be partially filled in the third openings 341, but adjacent sixth electrodes 372 are not connected to each other (that is, electrically insulated). With the above design, a sixth structure 60 is obtained. Next, the third cholesteric liquid crystal layer 33 is disposed on the fifth structure 50 or the sixth structure 60, and the fifth structure 50 and the sixth structure 60 are assembled to form the third panel 3. The stacked layers of the sixth structure 60 are only examples, and other stacked layers (other inorganic or organic layers), alignment layers (not shown), and wiring layers (not shown) may be added as required.

Then, as shown in FIG. 2, the first panel 1, the second panel 2, and the third panel 3 are assembled to form a reflective electronic device 100, wherein the second panel 2 may be disposed between the first panel 1 and the third panel 3. In one embodiment of the present disclosure, the first panel 1, the second panel 2, and the third panel 3 may be assembled through adhesive layers 4 to form a reflective electronic device 100. More specifically, the adhesive layers 4 may each be disposed between the first panel 1 and the second panel 2, and between the second panel 2 and the third panel 3.

In the present disclosure, as shown in FIG. 1A to FIG. 1C, the materials of the first black matrix layer BM1, the second black matrix layer BM2 and/or the third black matrix layer BM3 may be the same or different from each other. The materials of the first black matrix layer BM1, the second black matrix layer BM2, and the third black matrix layer BM3 may each include a black ink layer, a black resin layer, an anti-reflection material, or a light absorbing material, but the present disclosure is not limited thereto. In the present disclosure, the first black matrix layer BM1, the second black matrix layer BM2, and/or the third black matrix layer BM3 may overlap with each other. In the present disclosure, the first black matrix layer BM1, the second black matrix layer BM2 and/or the third black matrix layer BM3 may have similar outer contours. For example, the first black matrix layer BM1, the second black matrix layer BM2 and/or the third black matrix layer BM3 are annular and each surround the active area AA, but it is not limited thereto.

In one embodiment of the present disclosure, the first panel 1 may be a display panel used to reflect a blue color, the second panel 2 may be a display panel used to reflect a green color, and the third panel 3 may be a display panel used to reflect a red color, but the present disclosure is not limited thereto. The reflection colors of the first panel 1, the second panel 2 and the third panel 3 may be adjusted according to requirements. In other embodiments, the reflective electronic device 100 may selectively have fewer or more display panels, each for reflecting a different color.

In the present disclosure, the materials of the first color filter layer CF1 and/or the second color filter layer CF2 may be different from each other. As shown in FIG. 2, in one embodiment of the present disclosure, the first color filter layer CF1 is a yellow filter layer, and the second color filter layer CF2 is a red filter layer, but it is not limited thereto. The first color filter layer CF1 and the second color filter layer CF2 may be used to improve the color purity or vividness displayed by the reflective electronic device.

In the present disclosure, as shown in FIG. 1A to FIG. 1C, the materials of the first protective layer 19, the second protective layer 29 and/or the third protective layer 39 may be the same or different from each other. The materials of the first protective layer 19, the second protective layer 29 and/or the third protective layer 39 may each include an inorganic insulation layer or an organic insulation layer, other suitable transparent materials or a combination thereof, but it is not limited thereto. The thickness of the first protective layer 19, the second protective layer 29 and/or the third protective layer 39 may be between 1.0 μm and 2.0 μm (1.0 μm≤thickness≤2.0 μm) or between 1.2 μm and 1.8 μm (1. 2μm≤thickness≤1.8 μm), such as about 1.7 μm or 1.6 μm, but it is not limited thereto. In one embodiment of the present disclosure, the first protective layer 19, the second protective layer 29 and/or the third protective layer 39 may be flat and leveled, but the present disclosure is not limited thereto. In other embodiments of the present disclosure, the first protective layer 19, the second protective layer 29 and/or the third protective layer 39 may also present a shape with a middle protrusion (that is, a protrusion located in the active area AA) and two sides (that is, the parts located in the non-active area NAA) extending downward along the shape.

In the present disclosure, as shown in FIG. 1A to FIG. 1C, the photoresist types and photoresist materials of the first material layer 181, the second material layer 281, the third material layer 381, the fourth material layer 182, the fifth material layer 282 and/or the sixth material layer 382 may be the same or different from each other. The photoresist types of the first material layer 181, the second material layer 281, the third material layer 381, the fourth material layer 182, the fifth material layer 282 and/or the sixth material layer 382 may each be a positive photoresist or a negative photoresist, but the present disclosure is not limited thereto. In one embodiment of the present disclosure, as shown in FIG. 1A to FIG. 1C, the photoresist types of the first material layer 181, the second material layer 281, the third material layer 381, the fourth material layer 182, the fifth material layer 282 and the sixth material layer 382 may each be a negative photoresist, wherein the portion of such photoresist that is not irradiated with light may be dissolved during development, and the portion of such photoresist that is cured by light irradiation will be retained, but the present disclosure is not limited thereto.

In the present disclosure, as shown in FIG. 2, the exposure conditions of the first main spacer 15, the first secondary spacer 16, the second main spacer 25, the second secondary spacer 26, the third main spacer 35 and/or the third secondary spacer 36 may be the same or different from each other. In one embodiment of the present disclosure, the exposure conditions of the first main spacer 15, the first secondary spacer 16, the second main spacer 25, the second secondary spacer 26, the third main spacer 35 and the third secondary spacer 36 are, for example, under an illumination of 300 mj to 400 mj, such as 330 mj, 340 mj, 350 mj, 360 mj or 370 mj for about 40 minutes (for example, 35 minutes, 30 minutes or 25 minutes), but it is not limited thereto. However, the present disclosure is not limited thereto, and the exposure time and illumination may be adjusted according to the types of photoresist material of the first material layer 181, the second material layer 281, the third material layer 381, the fourth material layer 182, the fifth material layer 282 and/or the sixth material layer 382. For example, in one embodiment of the present disclosure, the exposure conditions (for example, illumination and/or time) of the first main spacer 15, the second main spacer 25 and/or the third main spacer 35 may be the same or different, and the exposure conditions (for example, illumination and/or time) of the first secondary spacer 16, the second secondary spacer 26 and/or the third secondary spacer 36 may be the same or different, but the exposure conditions (for example, illumination and/or time) of the main spacer (including the first main spacer 15, the second main spacer 25 and the third main spacer 35) and the secondary spacer (including the first secondary spacer 16, the second secondary spacer 26 and the third secondary spacer 36) are different. However, the present disclosure is not limited thereto.

In one embodiment of the present disclosure, the transmittance of the light in the wavelength band used in the photolithography process (such as UV light, but not limited thereto) to the first mask PS1 and/or the second mask PS2 may be greater than or equal to 80% and less than or equal to 100%. In one embodiment of the present disclosure, the transmittance of UV light (or light in the wavelength band used in the photolithography process) to the first mask PS1 and the second mask PS2 to may be approximately 100%.

In one embodiment of the present disclosure, as shown in FIG. 2, the first main spacer 15 and/or the first secondary spacer 16 may not overlap with or contact the plurality of first electrodes 171, the second main spacer 25 and/or the second secondary spacer 26 may not overlap with or contact the plurality of second electrodes 271, and the third main spacer 35 and/or the third secondary spacer 36 may not overlap with or contact the plurality of third electrodes 371. In some embodiments (not shown), the number of first main spacers 15 is smaller than the number of first secondary spacers 16, the number of second main spacers 25 is smaller than the number of second secondary spacers 26, and the number of third main spacers 35 is smaller than the number of third secondary spacers 36, but it is not limited thereto. In addition, as shown in FIG. 2, the first main spacer 15 and/or the first secondary spacer 16 may not overlap with or contact the plurality of fourth electrodes 172, the second main spacer 25 and/or the second secondary spacer 26 may not overlap with or contact the plurality of fifth electrodes 272, and the third main spacer 35 and/or the third secondary spacer 36 may not overlap with or contact the plurality of sixth electrodes 372.

As shown in FIG. 1A to FIG. 1C, in the present disclosure, the first material layer 181, the second material layer 281, the third material layer 381, the fourth material layer 182, the fifth material layer 282 and/or the sixth material layer 382 may be formed by, for example, spin coating. The faster the rotation speed of the spin coating is, the thinner the thickness of the formed material layer is, but the present invention is not limited thereto. The first thickness T1, the second thickness T2, the third thickness T3, the fourth thickness T4, the fifth thickness T5 and/or the sixth thickness T6 may be different from each other. In one embodiment of the present disclosure, the spin coating speed for forming the first material layer 181 may be greater than the spin coating speed for forming the second material layer 281, and the spin coating speed for forming the second material layer 281 may be greater than the spin coating speed for forming the third material layer 381. In addition, the spin coating speed for forming the fourth material layer 182 may be greater than the spin coating speed for forming the fifth material layer 282, and the spin coating speed for forming the fifth material layer 282 may be greater than the spin coating speed for forming the sixth material layer 382, but it is not limited thereto. In one embodiment of the present disclosure, the first material layer 181 may be formed by spin coating at about 900 rpm to 800 rpm, or at 870 rpm to 820 rpm, such as 812 rpm, 834 rpm, 847 rpm, 865 rpm, or 874 rpm. The second material layer 281 may be formed by spin coating at about 600 rpm to 720 rpm, or at 630 rpm to 700 rpm, such as 635 rpm, 641 rpm, 668 rpm, or 682 rpm. The third material layer 381 may be formed by spin coating at about 540 rpm to 680 rpm, or at 580 rpm to 660 rpm, such as 596 rpm, 614 rpm, 620 rpm, or 630 rpm to 700 rpm. The fourth material layer 182 may be formed by spin coating at 900 rpm to 1000 rpm, or at 920 rpm to 970 rpm, such as 932 rpm, 947 rpm, 950rpm or 986 rpm. The fifth material layer 282 may be formed by spin coating at 750 rpm to 850 rpm, or at 770 rpm to 830 rpm, such as 775 rpm, 786 rpm, 793 rpm or 813 rpm. The sixth material layer 382 may be formed by spin coating at 620 rpm to 740 rpm, or at 650 rpm to 710 rpm, such as 657 rpm, 672 rpm, 685 rpm or 699 rpm, but the present disclosure is not limited thereto. Therefore, the third thickness T3 may be greater than the second thickness T2, and the second thickness T2 may be greater than the first thickness T1. The sixth thickness T6 may be greater than the fifth thickness T5, and the fifth thickness T5 may be greater than the fourth thickness T4.

By matching the aforementioned material layers of different thicknesses with the first mask PS1 and the second mask PS2, respectively, the spacings of the cholesteric liquid crystal layers of the first panel, the second panel and the third panel of the reflective electronic device may be made different only by two masks, so as to achieve the purpose of making the cholesteric liquid crystal layer emit light of different colors, thereby simplifying the process and reducing the costs.

In the present disclosure, the first substrate 11, the second substrate 12, the third substrate 21, the fourth substrate 22, the fifth substrate 31 and/or the sixth substrate 32 may be hard substrates, soft substrates or flexible substrates. The materials of the first substrate 11, the second substrate 12, the third substrate 21, the fourth substrate 22, the fifth substrate 31 and/or the sixth substrate 32 may be the same or different from each other. The materials of the first substrate 11, the second substrate 12, the third substrate 21, the fourth substrate 22, the fifth substrate 31 and/or the sixth substrate 32 may each include glass, quartz, sapphire, ceramic, plastic, polycarbonate (PC), polyimide (PI), polypropylene (PP), polyethylene terephthalate (PET), polymethylmethacrylate (PMMA), other suitable materials or a combination thereof, but the present disclosure is not limited thereto. When the first substrate 11, the second substrate 12, the third substrate 21, the fourth substrate 22, the fifth substrate 31 and the sixth substrate 32 are flexible substrates, the reflective electronic device 100 of the present disclosure may be a flexible display device.

In the present disclosure, although not shown in the figures, active components (e.g., transistors), conductive lines (not shown), alignment layers (not shown), insulation layers (not shown), or a combination thereof may be provided on the third substrate 21, the fourth substrate 22, and the sixth substrate 32, but it is not limited thereto.

In one embodiment of the present disclosure, by controlling the thickness of the first cholesteric liquid crystal layer 13, the second cholesteric liquid crystal layer 23 and the third cholesteric liquid crystal layer 33, the first cholesteric liquid crystal layer 13, the second cholesteric liquid crystal layer 23 and the third cholesteric liquid crystal layer 33 may reflect light of different colors according to the design. In the present disclosure, the thicknesses of the first cholesteric liquid crystal layer 13, the second cholesteric liquid crystal layer 23 and the third cholesteric liquid crystal layer 33 are controlled by controlling the thicknesses of the first main spacer 15, the second main spacer 25 and the third main spacer 35. The detailed thickness relationship of the first main spacer 15, the second main spacer 25 and the third main spacer 35 will be described in detail hereinafter.

In the present disclosure, the materials of the first insulation layer 14, the second insulation layer 24 and/or the third insulation layer 34 may be the same or different from each other. The materials of the first insulation layer 14, the second insulation layer 24 and/or the third insulation layer 34 may each include silicon oxide, silicon oxynitride, silicon nitride, aluminum oxide, resin, polymer, photoresist, or a combination thereof, but the present disclosure is not limited thereto.

In the present disclosure, the materials of the first electrode layer 171, the second electrode layer 271, the third electrode layer 371, the fourth electrode layer 172, the fifth electrode layer 272 and/or the sixth electrode layer 372 may be the same or different from each other. The materials of the first electrode layer 171, the second electrode layer 271, the third electrode layer 371, the fourth electrode layer 172, the fifth electrode layer 272 and/or the sixth electrode layer 372 may each include a transparent conductive material, such as indium zinc oxide (IZO), indium tin oxide (ITO), indium tin zinc oxide (ITZO), indium gallium zinc oxide (IGZO), aluminum zinc oxide (AZO) or a combination thereof, but the present disclosure is not limited thereto.

FIG. 2 is a schematic diagram of a reflective electronic device according to an embodiment of the present disclosure. As shown in FIG. 2, in one embodiment of the present disclosure, a reflective electronic device 100 has a display surface and includes a first panel 1, a second panel 2, and a third panel 3. The first panel 1 includes a first substrate 11, a second substrate 12, a first cholesteric liquid crystal layer 13, a first insulation layer 14, and a first main spacer 15. The second substrate 12 is opposite to the first substrate 11. The first cholesteric liquid crystal layer 13 is disposed between the first substrate 11 and the second substrate 12. The first insulation layer 14 is disposed between the first cholesteric liquid crystal layer 13 and the second substrate 12, wherein the first insulation layer 14 has a first opening 141. The first main spacer 15 is disposed between the first substrate 11 and the second substrate 12 and has a first main surface 151, a second main surface 152 and a first main thickness MB. The first main surface 151 is adjacent to the first substrate 11, and the second main surface 152 is adjacent to the second substrate 12 and disposed in the first opening 141.

In addition, the first panel 1 may further include a first secondary spacer 16, which is disposed between the first substrate 11 and the second substrate 12 and has a first secondary surface 161, a second secondary surface 162 and a first secondary thickness SB, wherein the first secondary surface 161 is adjacent to the first substrate 11 and the second secondary surface 162 is opposite to the first secondary surface 161. Furthermore, the first panel 1 may further include a plurality of first electrodes 171 and a plurality of fourth electrodes 172, wherein the plurality of first electrodes 171 are disposed between the first substrate 11 and the first cholesteric liquid crystal layer 13, and the plurality of fourth electrodes 172 are disposed between the second substrate 12 and the first cholesteric liquid crystal layer 13. The plurality of first electrodes 171 and the plurality of fourth electrodes 172 may be intersected with each other to form a plurality of first pixel areas PX1. The first cholesteric liquid crystal layer 13 in the corresponding first pixel area PX1 may drive the arrangement of the first cholesteric liquid crystal layer 13 according to the electric field generated by the voltage applied between the corresponding first electrode 171 and the fourth electrode 172, thereby changing its state, for example, a reflective state (that is, a planar state), a transmissive state (focal conic state), or a homeotropic state. It should be noted that, although the widths of the first electrode 171 and the fourth electrode 172 shown in FIG. 2 are different, this is for illustrative purpose only, and the widths of the first electrode 171 and the fourth electrode 172 may also be close to each other.

As shown in FIG. 2, in one embodiment of the present disclosure, the second panel 2 includes a third substrate 21, a fourth substrate 22, a second cholesteric liquid crystal layer 23, a second insulation layer 24, and a second main spacer 25. The fourth substrate 22 is opposite to the third substrate 21. The second cholesteric liquid crystal layer 23 is disposed between the third substrate 21 and the fourth substrate 22. The second insulation layer 24 is disposed between the second cholesteric liquid crystal layer 23 and the fourth substrate 22, wherein the second insulation layer 24 has a second opening 241. The second main spacer 25 is disposed between the third substrate 21 and the fourth substrate 22 and has a third main surface 251, a fourth main surface 252 and a second main thickness MG. The third main surface 251 is adjacent to the third substrate 21, and the fourth main surface 252 is adjacent to the fourth substrate 22 and disposed in the second opening 241.

In addition, the second panel 2 may further include a second secondary spacer 26, which is disposed between the third substrate 21 and the fourth substrate 22 and has a third secondary surface 261, a fourth secondary surface 262 and a second secondary thickness SG, wherein the third secondary surface 261 is adjacent to the third substrate 21, and the fourth secondary surface 262 is opposite to the third secondary surface 261. Furthermore, the second panel 2 may further include a plurality of second electrodes 271 and a fifth electrode 272, wherein the plurality of second electrodes 271 are disposed between the third substrate 21 and the second cholesteric liquid crystal layer 23, and the plurality of fifth electrodes 272 are disposed between the fourth substrate 22 and the second cholesteric liquid crystal layer 23. The plurality of second electrodes 271 and the plurality of fifth electrodes 272 may be intersected with each other to form a plurality of second pixel areas PX2. The second cholesteric liquid crystal layer 23 in the corresponding second pixel area PX2 may be arranged to drive the second cholesteric liquid crystal layer 23 according to the electric field generated by the voltage applied between the corresponding second electrode 271 and the fifth electrode 272, thereby changing its state, for example, a reflective state (that is, a planar state), a transmissive state (focal conic state), or a homeotropic state. It should be noted that, although the widths of the second electrode 271 and the fifth electrode 272 shown in FIG. 2 are different, this is for illustrative purpose only, and the widths of the second electrode 271 and the fifth electrode 272 may also be close to each other.

As shown in FIG. 2, in one embodiment of the present disclosure, the third panel 3 includes a fifth substrate 31, a sixth substrate 32, a third cholesteric liquid crystal layer 33, a third insulation layer 34, and a third main spacer 35. The sixth substrate 32 is opposite to the fifth substrate 31.

The third cholesteric liquid crystal layer 33 is disposed between the fifth substrate 31 and the sixth substrate 32. The third insulation layer 34 is disposed between the third cholesteric liquid crystal layer 33 and the sixth substrate 32, wherein the third insulation layer 34 has a third opening 341.

The third main spacer 35 is disposed between the fifth substrate 31 and the sixth substrate 32 and has a fifth main surface 351, a sixth main surface 352 and a third main thickness MR, wherein the fifth main surface 351 is adjacent to the fifth substrate 31, and the sixth main surface 352 is adjacent to the sixth substrate 32 and disposed in the third opening 341.

In addition, the third panel 3 may further include a third secondary spacer 36, which is disposed between the fifth substrate 31 and the sixth substrate 32 and has a fifth secondary surface 361, a sixth sub0surface 362 and a third secondary thickness SR, wherein the fifth secondary surface 361 is adjacent to the fifth substrate 31 and the sixth secondary surface 362 is opposite to the fifth secondary surface 361. Furthermore, the third panel 3 may further include a plurality of third electrodes 371 and a plurality of sixth electrodes 372, wherein the plurality of third electrodes 371 are disposed between the fifth substrate 31 and the third cholesteric liquid crystal layer 33, and the plurality of sixth electrodes 372 are disposed between the sixth substrate 32 and the third cholesteric liquid crystal layer 33. The plurality of third electrodes 371 and the plurality of sixth electrodes 372 may be intersected with each other to form a plurality of third pixel areas PX3. The third cholesteric liquid crystal layer 33 in the corresponding third pixel area PX3 may drive the arrangement of the third cholesteric liquid crystal layer 33 according to the electric field generated by the voltage applied between the corresponding third electrode 371 and the sixth electrode 372, thereby changing its state, for example, a reflective state (that is, a planar state), a transmissive state (focal conic state), or a homeotropic state. It should be noted that, although the widths of the third electrode 371 and the sixth electrode 372 shown in FIG. 2 are different, this is for illustrative purpose only, and the widths of the third electrode 371 and the sixth electrode 372 may also be close to each other.

In the present disclosure, the first main thickness MB, the second main thickness MG and the third main thickness MR may be different from each other, and the first secondary thickness SB, the second secondary thickness SG and the third secondary thickness SR may be different from each other. In one embodiment of the present disclosure, the third main thickness MR may be greater than the second main thickness MG, and the second main thickness MG may be greater than the first main thickness MB. The third secondary thickness SR may be greater than the second secondary thickness SG, and the second secondary thickness SG may be greater than the first secondary thickness SB, but it is not limited thereto. For example, the third main thickness MR may be approximately 6.0 μm to 6.06 μm±0.2 μm, the second main thickness MG may be approximately 5.6 μm to 5.66 μm±0.2 μm, and the first main thickness MB may be approximately 4.40 μm to 4.46 μm±0.2 μm. The third secondary thickness SR may be approximately 5.47 μm to 5.5 3μm±0.2 μm, the second secondary thickness SG may be approximately 5.07 μm to 5.13 μm±0.2 μm, and the first secondary thickness SB may be approximately 3.88 μm to 3.94 μm±0.2 μm. In this case, the spacings between the first panel 1, the second panel 2 and/or the third panel 3 of the reflective electronic device 100 may be different from each other, that is, the thicknesses of the first cholesteric liquid crystal layer 13, the second cholesteric liquid crystal layer 23 and/or the third cholesteric liquid crystal layer 33 are different, so as to achieve the purpose of reflecting light of different colors when the aforementioned cholesteric liquid crystal layers are switched to the reflective state. For example, the first panel 1 may reflect blue light, the second panel 2 may reflect green light, and the third panel 3 may reflect red light, but it is not limited thereto. The color of light reflected by the first panel 1, the second panel 2, and/or the third panel 3 may be designed according to requirements.

In the present disclosure, the first secondary thickness SB may be different from the first main thickness MB, the second secondary thickness SG may be different from the second main thickness MG, and the third secondary thickness SR may be different from the third main thickness MR. In one embodiment of the present disclosure, the first secondary thickness SB may be smaller than the first main thickness MB, the second secondary thickness SG may be smaller than the second main thickness MG, and the third secondary thickness SR may be smaller than the third main thickness MR.

In one embodiment of the present disclosure, the difference between the first main thickness MB and the first secondary thickness SB is a first difference, the difference between the second main thickness MG and the second secondary thickness SG is a second difference, and the difference between the third main thickness MR and the third secondary thickness SR is a third difference. The first difference, the second difference and the third difference may be each between 0.35 μm and 0.55 μm, such as about 0.45 μm or about 0.48 μm, but it is not limited thereto.

In one embodiment of the present disclosure, a ratio of the first main thickness MB to the first secondary thickness SB is a first ratio, a ratio of the second main thickness MG to the second secondary thickness SG is a second ratio, and a ratio of the third main thickness MR to the third secondary thickness SR is a third ratio. The first ratio, the second ratio, and the third ratio may satisfy the following relationship:
R3<R2<R1,
   where R1 is a first ratio, R2 is a second ratio, and R3 is a third ratio.

In one embodiment of the present disclosure, a first ratio of the first main thickness MB to the first secondary thickness SB may be approximately 1.12 to 1.14 (1.12≤first ratio≤1.14), a second ratio of the second main thickness MG to the second secondary thickness SG may be approximately 1.08 to 1.1 (1.08≤second ratio≤1.1), and a third ratio of the third main thickness MR to the third secondary thickness SR may be approximately 1.06˜1.08 (1.06≤third ratio≤1.08), but the present disclosure is not limited thereto.

In the present disclosure, on the cross-section of the reflective electronic device 100, the width WB1 of the first main surface 151, the width WG1 of the third main surface 251 and the width WR1 of the fifth main surface 351 may be the same or different from each other, and the width WB2 of the second main surface 152, the width WG2 of the fourth main surface 252 and the width WR2 of the sixth main surface 352 may be the same or different from each other. In one embodiment of the present disclosure, in the cross section of the reflective electronic device 100, the width WB1 of the first main surface 151 may be greater than or equal to the width WG1 of the third main surface 251, and the width WG1 of the third main surface 251 may be greater than or equal to the width WR1 of the fifth main surface 351. The width WB2 of the second main surface 152 may be greater than the width WG2 of the fourth main surface 252, and the width WG2 of the fourth main surface 252 may be greater than the width WR2 of the sixth main surface 352. That is, on the cross-section of the reflective electronic device 100, the size trends of the width WB2 of the second main surface 152, the width WG2 of the fourth main surface 252 and the width WR2 of the sixth main surface 352 are inversely proportional to the size trends of the first main thickness MB, the second main thickness MG and the third main thickness MR. In more detail, the width WB2 of the second main surface 152 is greater than the width WG2 of the fourth main surface 252, and the width WG2 of the fourth main surface 252 is greater than the width WR2 of the sixth main surface 352; but the first main thickness MB is smaller than the second main thickness MG, and the second main thickness MG is smaller than the third main thickness MR.

In one embodiment of the present disclosure, the width WB1 of the first main surface 151 may be greater than the width WB2 of the second main surface 152, the width WG1 of the third main surface 251 may be greater than the width WG2 of the fourth main surface 252, and/or the width WR1 of the fifth main surface 351 may be greater than the width WR2 of the sixth main surface 352. In one embodiment of the present disclosure, the ratio of the width WB1 of the first main surface 151 to the width WB2 of the second main surface 152 may be greater than or equal to 1 and less than or equal to 2.5 (1≤ratio23 2.5), the ratio of the width WG1 of the third main surface 251 to the width WG2 of the fourth main surface 252 may be greater than or equal to 1 and less than or equal to 2.5 (1≤ratio≤2.5), and/or the ratio of the width WR1 of the fifth main surface 351 to the width WR2 of the sixth main surface 352 may be greater than or equal to 1 and less than or equal to 2.5 (1≤ratio≤2.5). The ratio of the width WB1 of the first main surface 151 to the width WB2 of the second main surface 152 may be greater than or equal to 1.2 and less than or equal to 2.5 (1.2≤ratio≤2.5), the ratio of the width WG1 of the third main surface 251 to the width WG2 of the fourth main surface 252 may be greater than or equal to 1.2 and less than or equal to 2.5 (1.2≤ratio≤2.5), and/or the ratio of the width WR1 of the fifth main surface 351 to the width WR2 of the sixth main surface 352 may be greater than or equal to 1.2 and less than or equal to 2.5 (1.2≤ratio≤2.5).

In the present disclosure, although not shown, the area of the first main surface 151 may be larger than the area of the second main surface 152, the area of the third main surface 251 may be larger than the area of the fourth main surface 252, and/or the area of the fifth main surface 351 may be larger than the area of the sixth main surface 352. In the present disclosure, the area of the main surface refers to the area of the main surface projected on the surface of the substrate adjacent to the main surface in the top-view direction Z. When the widths or areas of the first major surface 151, the second major surface 152, the third major surface 251, the fourth major surface 252, the fifth major surface 351, and the sixth major surface 352 meet the aforementioned design, the alignment accuracy in forming the panel can be improved.

In the present disclosure, the second main surface 152, the fourth main surface 252 and the sixth main surface 352 are respectively disposed in the first opening 141, the second opening 241 and the third opening 341, for example. The second main surface 152 may not contact the fourth electrode 172, the fourth major surface 252 may not contact the fifth electrode 272, and the sixth main surface 352 may not contact the sixth electrode 372, but the present disclosure is not limited thereto. The second main surface 152 may not contact the first insulation layer 14, the fourth main surface 252 may not contact the second insulation layer 24, and the sixth main surface 352 may not contact the third insulation layer 34, but it is not limited thereto.

In one embodiment of the present disclosure, the width WB3 of the first secondary surface 161 may be greater than the width WB4 of the second secondary surface 162, the width WG3 of the third secondary surface 261 may be greater than the width WG4 of the fourth secondary surface 262, and/or the width WR3 of the fifth secondary surface 361 may be greater than the width WR4 of the sixth secondary surface 362. In one embodiment of the present disclosure, the ratio of the width WB3 of the first secondary surface 161 to the width WB4 of the second secondary surface 162 may be greater than or equal to 1 and less than or equal to 2.5 (1≤ratio≤2.5), the ratio of the width WG3 of the third secondary surface 261 to the width WG4 of the fourth secondary surface 262 may be greater than or equal to 1 and less than or equal to 2.5 (1≤ratio≤2.5), and/or the ratio of the width WR3 of the fifth secondary surface 361 to the width WR4 of the sixth secondary surface 362 may be greater than or equal to 1 and less than or equal to 2.5 (1≤ratio ≤2.5). More specifically, the ratio of the width WB3 of the first secondary surface 161 to the width WB4 of the second secondary surface 162 may be greater than or equal to 1.2 (or 1.4) and may be less than or equal to 2 (or 1.8) (1.2 (or 1.4)≤ratio≤2 (or 1.8)), the ratio of the width WG3 of the third secondary surface 261 to the width WG4 of the fourth secondary surface 262 may be greater than or equal to 1.2 and may be less than or equal to 2 (1.2 (or 1.4)≤ratio≤2 (or 1.8)), and/or the ratio of the width WR3 of the fifth secondary surface 361 to the width WR4 of the sixth secondary surface 362 may be greater than or equal to 1.2 (or 1.4) and may be less than or equal to 2 (or 1.8) (1.2 (or 1.4)≤ratio≤2 (or 1.8)).

In the present disclosure, although not shown, the area of the first secondary surface 161 may be larger than the area of the second secondary surface 162, the area of the third secondary surface 261 may be larger than the area of the fourth secondary surface 262, and/or the area of the fifth secondary surface 361 may be larger than the area of the sixth secondary surface 362. In the present disclosure, the area of the secondary surface refers to the area of the secondary surface projected on the surface of the substrate adjacent to the secondary surface in the top-view direction Z. In the present disclosure, the second secondary surface 162, the fourth secondary surface 262, and the sixth secondary surface 362 are selectively respectively disposed in or not disposed in the fourth opening 142, the fifth opening 242, and the sixth opening 342, for example. The second secondary surface 162 may not contact the fourth electrode 172, the fourth secondary surface 262 may not contact the fifth electrode 272, and the sixth secondary surface 362 may not contact the sixth electrode 372, but the present disclosure is not limited thereto. The second secondary surface 162 may not contact the first insulation layer 14, the fourth secondary surface 262 may not contact the second insulation layer 24, and the sixth secondary surface 362 may not contact the third insulation layer 34, but it is not limited thereto.

In the present disclosure, as shown in FIG. 1D, the spacing W2 between two adjacent fourth electrodes 172 corresponding to the first main spacer 16 may be greater than the spacing W1 between two adjacent fourth electrodes 172 corresponding to the first main spacer 15, the spacing W4 between two adjacent fifth electrodes 272 corresponding to the second main spacer 26 may be greater than the spacing W3 between two adjacent fifth electrodes 272 corresponding to the second main spacer 25, and/or the spacing W6 between two adjacent sixth electrodes 372 corresponding to the third main spacer 36 may be greater than the spacing W5 between two adjacent sixth electrodes 372 corresponding to the third main spacer 35.

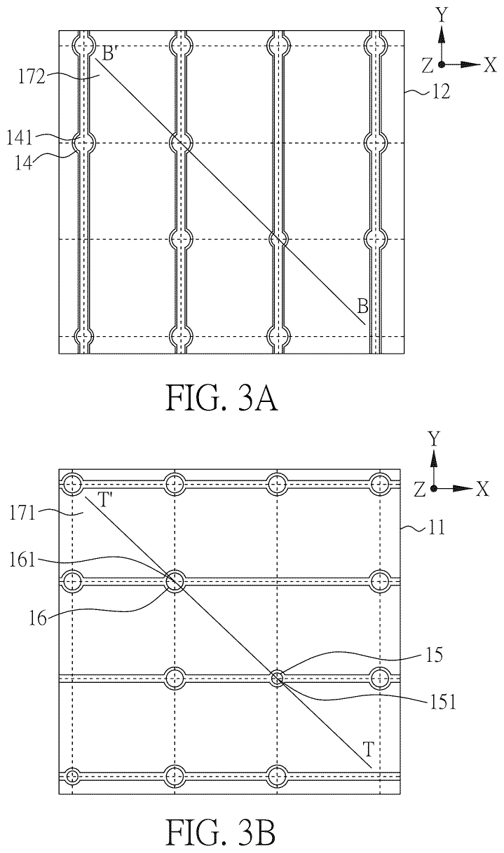

FIG. 3A and FIG. 3B are schematic diagrams of a second substrate and a first substrate, respectively, according to an embodiment of the present disclosure. As shown in FIG. 3A and FIG. 3B, in one embodiment of the present disclosure, in the top-view direction Z, the shapes of the first main surface 151, the second main surface 152, the first secondary surface 161, and the second secondary surface 162 may be circular, elliptical, triangular, rectangular, or irregular, but the present disclosure is not limited thereto. Similarly, although not shown, the shapes of the third main surface 251, the fourth main surface 252, the fifth main surface 351, the sixth main surface 352, the third secondary surface 261, the fourth secondary surface 262, the fifth secondary surface 361 and the sixth secondary surface 362 may also be circular, elliptical, triangular, rectangular or irregular, respectively. In the present disclosure, the shape of the main surface (or the secondary surface) refers to the shape of the projection of the main surface (or the secondary surface) on the surface of the substrate adjacent to the main surface (or the secondary surface) in the top-view direction Z.

In addition, in one embodiment of the present disclosure, as shown in FIG. 3A and FIG. 3B, the first main spacer 15 and the first secondary spacer 16 may not overlap and/or contact the plurality of first electrodes 171. The plurality of fourth electrodes 172 are sequentially arranged along the direction X, for example, and each of the fourth electrodes 172 extends along the direction Y, for example. The plurality of first electrodes 171 are sequentially arranged along the direction Y, for example, and each first electrode 171 extends along the direction X, for example.

Similarly, although not shown, the second main spacer 25 and the second secondary spacer 26 may not overlap and/or contact the plurality of second electrodes 271, and the third main spacer 35 and the third secondary spacer 36 may not overlap and/or contact the plurality of third electrodes 371. In this way, the influence of the spacer on the active area may be reduced, for example, the influence of the spacer on the display quality of the cholesteric liquid crystal layer may be reduced. Similarly (referring to FIG. 2), the plurality of fifth electrodes 272 are sequentially arranged along the direction X, for example, and each fifth electrode 272 extends along the direction Y, for example. The plurality of second electrodes 271 are sequentially arranged along the direction Y, for example, and each second electrode 271 extends along the direction X, for example. Similarly, the plurality of sixth electrodes 372 are sequentially arranged along the direction X, for example, and each sixth electrode 372 extends along the direction Y, for example. The plurality of third electrodes 371 are sequentially arranged along the direction Y, for example, and each of the third electrodes 371 extends along the direction X, for example.

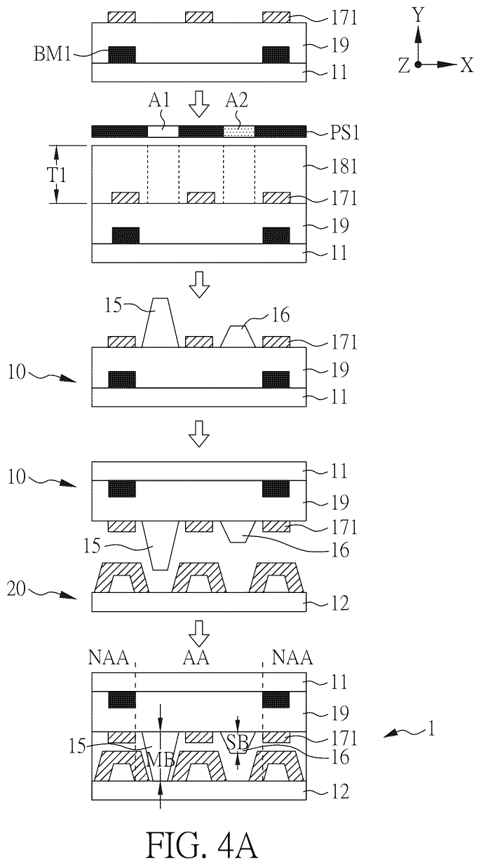

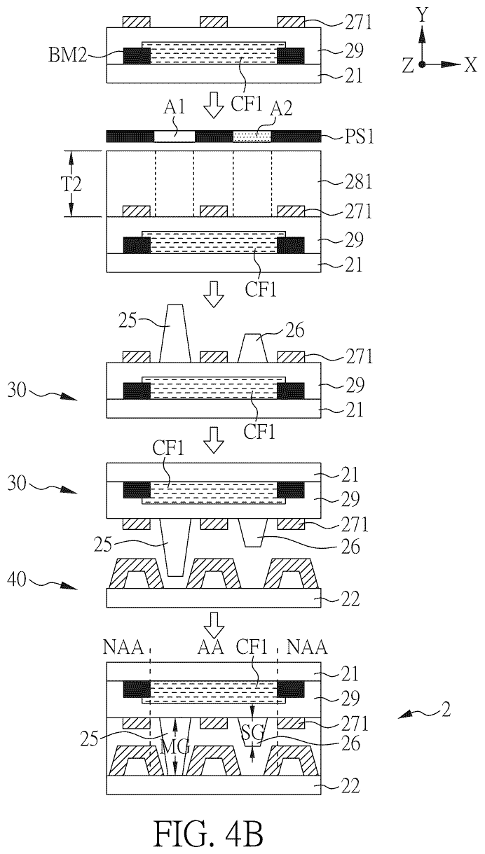

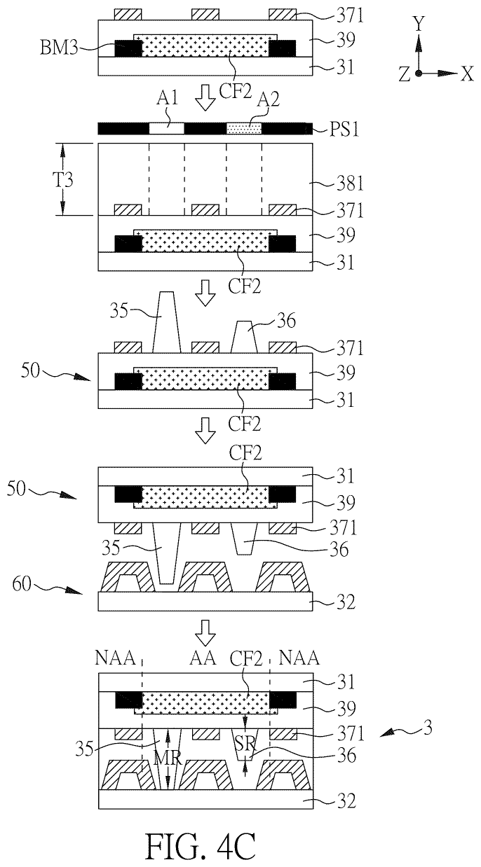

FIG. 4A is a schematic diagram showing the preparation of a first panel of a reflective electronic device according to another embodiment of the present disclosure. The preparation method shown in FIG. 4A is similar to that shown in FIG. 1A, except for the following differences. As shown in FIG. 4A, the first material layer 181 is patterned using a first mask PS1 to simultaneously form a first main spacer 15 and a first secondary spacer 16, wherein the first mask PS1 includes a first area A1 and a second area A2, the first area A1 corresponds to the area of the first material layer 181 where the first main spacer 15 is formed, and the second area A2 corresponds to the area of the first material layer 181 where the first secondary spacer 16 is formed.

FIG. 4B is a schematic diagram showing the preparation of a second panel of a reflective electronic device according to another embodiment of the present disclosure. The preparation method shown in FIG. 4B is similar to that shown in FIG. 1B, except for the following differences. As shown in FIG. 4B, the first mask PS1 is used to pattern the second material layer 281 to simultaneously form the second main spacer 25 and the second secondary spacer 26, wherein the first area A1 corresponds to the area of the second material layer 281 where the second main spacer is formed, and the second area A2 corresponds to the area of the second material layer 281 where the second secondary spacer 26 is formed.

FIG. 4C is a schematic diagram showing the preparation of a third panel of a reflective electronic device according to another embodiment of the present disclosure. The preparation method shown in FIG. 4C is similar to that shown in FIG. 1C, except for the following differences. As shown in FIG. 4C, the first mask PS1 is used to pattern the third material layer 381 to simultaneously form the third main spacer 35 and the third secondary spacer 36, wherein the first area A1 corresponds to the area of the third material layer 381 where the third main spacer is formed, and the second area A2 corresponds to the area of the third material layer 381 where the third secondary spacer 36 is formed.

As shown in FIG. 4A to FIG. 4C, a single mask may be used to form the first main spacer 15 and the first secondary spacer 16, the second main spacer 25 and the second secondary spacer 26, and the third main spacer 35 and the third secondary spacer 36 respectively by different transmittances of different areas thereof.

In addition, in the present disclosure, the first material layer 181, the second material layer 281 and the third material layer 381 may be formed by, for example, spin coating, but it is not limited thereto. In one embodiment of the present disclosure, the first thickness T1 of the first material layer 181, the second thickness T2 of the second material layer 281, and the third thickness T3 of the third material layer 381 may be the same or different from each other. In one embodiment of the present disclosure, the spin coating speed for forming the first material layer 181 may be greater than the spin coating speed for forming the second material layer 281, and the spin coating speed for forming the second material layer 281 may be greater than the spin coating speed for forming the third material layer 381. Therefore, the spacings of the first panel 1, the second panel 2 and the third panel 3 of the reflective electronic device may be made different by only one mask, that is, the thicknesses of the first cholesteric liquid crystal layer 13, the second cholesteric liquid crystal layer 23 and the third cholesteric liquid crystal layer 33 are different, so as to achieve the purpose of enabling the aforementioned cholesteric liquid crystal layers to reflect different colors of light in the reflective state, which may further simplify the process and reduce costs. The aforementioned thicknesses are each, for example, the average thickness of any three locations of the material layer.

In the present disclosure, the exposure conditions of the first main spacer 15, the first secondary spacer 16, the second main spacer 25, the second secondary spacer 26, the third main spacer 35 and the third secondary spacer 36 may be the same or different from each other. In one embodiment of the present disclosure, the exposure conditions of the first main spacer 15 and the first secondary spacer 16 are, for example, at an illumination of 250 mj to 350 mj, such as 286 mj, 292 mj, 300 mj, or 324 mj, for about 20 to 30 minutes. The exposure conditions of the second main spacer 25 and the second secondary spacer 26 are, for example, at an illumination of 230 mj to 330 mj, such as 253 mj, 266 mj, 276 mj, or 304 mj, for 20 to 30 minutes. The exposure conditions of the third main spacer 35 and the third secondary spacer 36 are, for example, at an illumination of 230 mj to 330 mj, such as 284 mj, 295 mj, 280 mj, or 306 mj, for 20 to 30 minutes. However, the present disclosure is not limited thereto, and the exposure time and illumination may be adjusted according to the types of photoresist materials of the first material layer 181, the second material layer 281, and the third material layer 381 and/or the thickness design of the spacers and secondary spacers.

In the present disclosure, the transmittance of the light in the wavelength band used in the photolithography process (for example, UV light) to the first area A1 may be different from the transmittance of the light in the wavelength band used in the photolithography process (for example, UV light) to the second area A2. In other words, the transmittance of the light used in patterning the material layers (photolithography process) to the first area A1 may be different from the transmittance of the light used in patterning (photolithography process) to the second area A2. In the present disclosure, the transmittance of the light in the wavelength band used in the photolithography process (for example, UV light) to the first area A1 may be greater than the transmittance of the light in the wavelength band used in the photolithography process (for example, UV light) to the second area A2. In other words, the transmittance of the light used in patterning the material layers (photolithography process) to the first area A1 may be greater than the transmittance of the light used in patterning (photolithography process) to the second area A2. In the present disclosure, the transmittance of the light in the wavelength band used in the photolithography process (for example, UV light) to the first area A1 may be greater than or equal to 80% and may be less than or equal to 100% (80%≤transmittance≤100%). For example, the transmittance of the light in the wavelength band used in the photolithography process (for example, UV light) to the first area A1 may be approximately 100%. The transmittance of the light in the wavelength band used in the photolithography process (for example, UV light) to the second area A2 may be greater than or equal to 25% and may be less than or equal to 55% (25% ≤transmittance≤55%). For example, the transmittance of the light in the wavelength band used in the photolithography process (for example, UV light) to the second area A2 may be approximately 40%, 35% or 30%. In other words, the transmittance of the light used in patterning the aforementioned material layers (photolithography process) to the first area A1 may be greater than or equal to 80% and may be less than or equal to 100% (80%≤transmittance≤100%). For example, the transmittance of the light used in patterning the aforementioned material layers (photolithography process) to the first area A1 may be approximately 100%. The transmittance of the light used in patterning the aforementioned material layers (photolithography process) to the second area A2 may be greater than or equal to 25% and may be less than or equal to 55% (25% ≤transmittance≤55%). For example, the transmittance of the light used in patterning the aforementioned material layers (photolithography process) to the second area A2 may be approximately 40%, 35% or 30%.

In the present disclosure, other features of component, material and so on of the reflective electronic device of FIG. 4A to FIG. 4C may be as described above and will not be repeated here. The stacking of the first structure 10 and the second structure 20 in FIG. 4A is only an example, and other stacking layers (other inorganic or organic layers), alignment layers (not shown), and wiring layers (not shown) may be added as required. The stacking of the third structure 30 and the fourth structure 40 in FIG. 4B is only an example, and other stacking layers (other inorganic or organic layers), alignment layers (not shown), and wiring layers (not shown) may be added as required. The stacking of the fifth structure 50 and the sixth structure 60 in FIG. 4C is only an example, and other stacking layers (other inorganic or organic layers), alignment layers (not shown), and wiring layers (not shown) may be added as required. Similar to FIG. 1D and FIG. 2, the first structure 10 and the second structure 20 are assembled to form a first panel 1, the third structure 30 and the fourth structure 40 are assembled to form a second panel 2, and the fifth structure 50 and the sixth structure 60 are assembled to form a third panel 3. Then, the first panel 1, the second panel 2 and the third panel 3 are assembled to form a reflective electronic device 100, wherein the second panel 2 may be disposed between the first panel 1 and the third panel 3. In one embodiment of the present disclosure, the first panel 1, the second panel 2, and the third panel 3 may be assembled through an adhesive layer 4 to form a reflective electronic device 100. As shown in FIG. 4A to FIG. 4C, the first secondary thickness SB of the first secondary spacer 16 is less than the first main thickness MB (the thickness of the first main spacer 15), the second secondary thickness SG of the second secondary spacer 26 is less than the second main thickness MG (the thickness of the second main spacer 25), the third secondary thickness SR of the third secondary spacer 36 is less than the third main thickness MR (the thickness of the third main spacer 35), and the first secondary thickness SB of the first secondary spacer 16, the second secondary thickness SG of the second secondary spacer 26 and the third secondary thickness SR of the third secondary spacer 36 are different from each other.

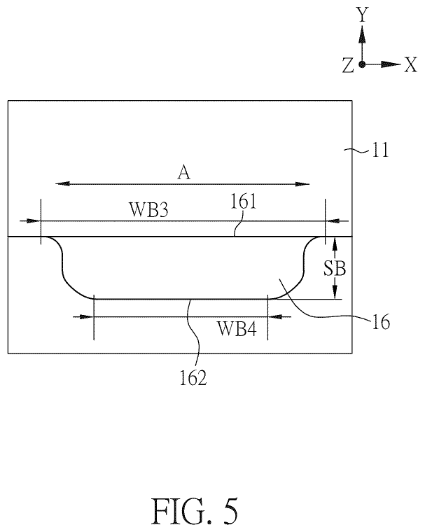

FIG. 5 is a cross-sectional view of the first secondary spacer of the reflective electronic device according to an embodiment of the present disclosure. As shown in FIG. 5, in one embodiment of the present disclosure, by taking the first secondary spacer 16 having an arc edge as an example, the width WB3 of the first secondary surface 161 is defined to be the overlap between the first secondary surface 161 of the first secondary spacer 16 and the parallel line A, and the width WB4 of the second secondary surface 162 is defined to be the overlap between the second secondary surface 162 of the first secondary spacer 16 and the parallel line A, wherein the parallel line A is a virtual line parallel to the surface of the first substrate 11 in the cross-sectional view. In the reflective electronic device disclosed in the present disclosure, when other spacers or secondary spacers have arc edges, the widths of different surfaces may be defined in a similar manner to the above. For example, the definitions of the remaining widths, including the width WB1 of the first main surface 151, the width WB2 of the second main surface 152, the width WG1 of the third main surface 251, the width WG2 of the fourth main surface 252, the width WR1 of the fifth main surface 351, the width WR2 of the sixth main surface 352, the width WG3 of the third secondary surface 261, the width WG4 of the fourth secondary surface 262, the width WR3 of the fifth secondary surface 361 and the width WR4 of the sixth secondary surface 362, are the same as those herein and thus are not described separately.

The aforementioned specific embodiments should be construed as merely illustrative, and not limiting the rest of the present disclosure in any way.

1. A reflective electronic device having a display surface and comprises:
a first panel including:
a first substrate;
a second substrate opposite to the first substrate;
a first cholesteric liquid crystal layer disposed between the first substrate and the second substrate;
a first insulation layer disposed between the first cholesteric liquid crystal layer and the second substrate, wherein the first insulation layer has a first opening; and
a first main spacer disposed between the first substrate and the second substrate and provided with a first main surface, a second main surface and a first main thickness, wherein the first main surface is adjacent to the first substrate, the second main surface is adjacent to the second substrate, and an area of the first main surface is larger than an area of the second main surface; and
a second panel including:
a third substrate;
a fourth substrate opposite to the third substrate;
a second cholesteric liquid crystal layer disposed between the third substrate and the fourth substrate;
a second insulation layer disposed between the second cholesteric liquid crystal layer and the fourth substrate, wherein the second insulation layer has a second opening; and
a second main spacer disposed between the third substrate and the fourth substrate and provided with a third main surface, a fourth main surface and a second main thickness, wherein the third main surface is adjacent to the third substrate, the fourth main surface is adjacent to the fourth substrate, and an area of the third main surface is larger than an area of the fourth main surface,
wherein the second main surface is disposed in the first opening, the fourth main surface is disposed in the second opening, and the second main thickness is greater than the first main thickness.

2. The reflective electronic device as claimed in claim 1, wherein the first panel further includes:
a first secondary spacer disposed between the first substrate and the second substrate, wherein the first secondary spacer has a first secondary thickness smaller than the first main thickness; and
a plurality of first electrodes disposed between the first substrate and the first cholesteric liquid crystal layer, wherein the first main spacer and the first secondary spacer do not overlap with the plurality of first electrodes.

3. The reflective electronic device as claimed in claim 1, further comprising a third panel including:
a fifth substrate;
a sixth substrate opposite to the fifth substrate;
a third cholesteric liquid crystal layer disposed between the fifth substrate and the sixth substrate;
a third insulation layer disposed between the third cholesteric liquid crystal layer and the sixth substrate, wherein the third insulation layer has a third opening; and
a third main spacer disposed between the fifth substrate and the sixth substrate and provided with a fifth main surface, a sixth main surface and a third main thickness, wherein the fifth main surface is adjacent to the fifth substrate, the sixth main surface is adjacent to the sixth substrate, and an area of the fifth main surface is larger than an area of the sixth main surface, wherein the sixth main surface is disposed in the third opening, and the third main thickness is greater than the second main thickness.

4. The reflective electronic device as claimed in claim 3, wherein, in a cross-section of the reflective electronic device, a width of the second main surface is greater than a width of the fourth main surface, and the width of the fourth main surface is greater than a width of the sixth main surface.

5. The reflective electronic device as claimed in claim 3, wherein the first panel includes a first secondary spacer disposed between the first substrate and the second substrate and provided with a first secondary thickness smaller than the first main thickness, the second panel includes a second secondary spacer disposed between the third substrate and the fourth substrate and provided with a second secondary thickness smaller than the second main thickness, and the third panel includes a third secondary spacer disposed between the fifth substrate and the sixth substrate and provided with a third secondary thickness smaller than the third main thickness, in which the third secondary thickness is greater than the second secondary thickness, and the second secondary thickness is greater than the first secondary thickness.

6. The reflective electronic device as claimed in claim 5, wherein a ratio of the first main thickness to the first secondary thickness is a first ratio, a ratio of the second main thickness to the second secondary thickness is a second ratio, a ratio of the third main thickness to the third secondary thickness is a third ratio, and the first ratio, the second ratio, and the third ratio satisfy:
R3<R2<R1,
where R1 represents the first ratio, R2 represents the second ratio, and R3 represents the third ratio.

7. The reflective electronic device as claimed in claim 2, wherein the first panel further includes a plurality of fourth electrodes disposed between the second substrate and the first cholesterol liquid crystal layer, and the plurality of first electrodes and the plurality of fourth electrodes are intersected to form a plurality of first pixel areas.

8. The reflective electronic device as claimed in claim 5, wherein the second panel further includes a plurality of second electrodes disposed between the third substrate and the second cholesterol liquid crystal layer, and a plurality of fifth electrodes disposed between the fourth substrate and the second cholesterol liquid crystal layer, and the plurality of second electrodes and the plurality of fifth electrodes are intersected with each other to form a plurality of second pixel areas.

9. The reflective electronic device as claimed in claim 5, wherein the third panel further includes a plurality of third electrodes disposed between the fifth substrate and the third cholesterol liquid crystal layer and a plurality of sixth electrodes disposed between the sixth substrate and the third cholesterol liquid crystal layer, and the plurality of third electrodes and the plurality of sixth electrodes are intersected with each other to form a plurality of third pixel areas.

10. The reflective electronic device as claimed in claim 5, wherein a difference between the first main thickness and the first secondary thickness is a first difference, a difference between the second main thickness and the second secondary thickness is a second difference, a difference between the third main thickness and the third secondary thickness is a third difference, and the first difference, the second difference and the third difference are each between 0.35 μm and 0.55 μm.

11. The reflective electronic device as claimed in claim 5, wherein a first ratio of the first main thickness to the first secondary thickness is 1.12 to 1.14, a second ratio of the second main thickness to the second secondary thickness is 1.08 to 1.1, and a third ratio of the third main thickness to the third secondary thickness is 1.06 to 1.08.

12. The reflective electronic device as claimed in claim 4, wherein a width of the first main surface is greater than or equal to a width of the third main surface, and a width of the third main surface is greater than or equal to a width of the fifth main surface.

13. The reflective electronic device as claimed in claim 7, wherein a distance between two adjacent fourth electrodes corresponding to the first secondary spacer is greater than a distance between two adjacent fourth electrodes corresponding to the first main spacer.

14. The reflective electronic device as claimed in claim 8, wherein a distance between two adjacent fifth electrodes corresponding to the second secondary spacer is greater than a distance between two adjacent fifth electrodes corresponding to the second main spacer.

15. A preparation method of a reflective electronic device, comprising:
forming a first structure, including forming a first material layer having a first thickness on a first substrate, and using a first mask to pattern the first material layer to form a first main spacer;
forming a second structure, wherein the second structure includes a second substrate;
disposing a first cholesteric liquid crystal layer on the first structure or the second structure, and assembling the first structure and the second structure to form a first panel;
forming a third structure, including forming a second material layer having a second thickness on a third substrate, and using the first mask to pattern the second material layer to form a second main spacer;
forming a fourth structure, wherein the fourth structure includes a fourth substrate;
disposing a second cholesteric liquid crystal layer on the third structure or the fourth structure, and assembling the third structure and the fourth structure to form a second panel; and
assembling the first panel and the second panel,
wherein the first thickness is different from the second thickness, and a first main thickness of the first main spacer is different from a second main thickness of the second main spacer.

16. The preparation method as claimed in claim 15, further comprising:
forming a fifth structure, including forming a third material layer having a third thickness on a fifth substrate, and using the first mask to pattern the third material layer to form a third main spacer;
forming a sixth structure, wherein the sixth structure includes a sixth substrate;
disposing a third cholesteric liquid crystal layer on the fifth structure or the sixth structure, and assembling the fifth structure and the sixth structure to form a third panel; and
assembling the first panel, the second panel and the third panel, wherein the third thickness is different from the first thickness and the second thickness, and the first main thickness of the first main spacer, the second main thickness of the second main spacer, and a third main thickness of the third main spacer are different from each other.

17. The preparation method as claimed in claim 16, further comprising:
when forming the first structure, further forming a fourth material layer having a fourth thickness on the first substrate, and using a second mask to pattern the fourth material layer to form a first secondary spacer;
when forming the third structure, further forming a fifth material layer having a fifth thickness on the third substrate, and using the second mask to pattern the fifth material layer to form a second secondary spacer; and
when forming the fifth structure, further forming a sixth material layer having a sixth thickness on the fifth substrate, and using the second mask to pattern the sixth material layer to form a third secondary spacer,
wherein the fourth thickness, the fifth thickness and the sixth thickness are different from each other, and a first secondary thickness of the first secondary spacer, a second secondary thickness of the second secondary spacer and a third secondary thickness of the third secondary spacer are different from each other.

18. The preparation method as claimed in claim 17, wherein the first secondary thickness is smaller than the first main thickness, the second secondary thickness is smaller than the second main thickness, and the third secondary thickness is smaller than the third main thickness.

19. The preparation method as claimed in claim 16, wherein the first mask is used to pattern the first material layer to simultaneously form the first main spacer and a first secondary spacer, in which the first mask includes a first area and a second area, the first area corresponds to an area of the first material layer where the first main spacer is formed, and the second area corresponds to an area of the first material layer where the first secondary spacer is formed; the first mask is used to pattern the second material layer to simultaneously form the second main spacer and a second secondary spacer, in which the first area corresponds to an area of the second material layer where the second main spacer is formed, and the second area corresponds to an area of the second material layer where the second secondary spacer is formed; the first mask is used to pattern the third material layer to simultaneously form the third main spacer and a third secondary spacer, in which the first area corresponds to an area of the third material layer where the third main spacer is formed, and the second area corresponds to an area of the third material layer where the third secondary spacer is formed; wherein a first secondary thickness of the first secondary spacer is less than the first main thickness, a second secondary thickness of the second secondary spacer is less than the second main thickness, a third secondary thickness of the third secondary spacer is less than the third main thickness, and the first secondary thickness of the first secondary spacer, a second secondary thickness of the second secondary spacer and a third secondary thickness of the third secondary spacer are different from each other; wherein a transmittance of light used in patterning to the first area is different from a transmittance of light used in patterning to the second area.

20. The preparation method as claimed in claim 19, wherein the transmittance of the light used in patterning to the first area is greater than or equal to 80% and less than or equal to 100%, and the transmittance of the light used in patterning to the second area is greater than or equal to 25% and less than or equal to 55%.
